(19) United States
(12) Patent Application Publication
(10) Pub. No.: US 2008/0073495 A1
(43) Pub. Date: Mar. 27, 2008

(54) Portable remote camera and radiation monitor

(75) Inventors: Frank M. Heckendorn, Aiken, SC (US); Kurt D. Peterson, Aiken, SC (US); Daniel M. Odell, Aiken, SC (US); Larry J. Harpring, North Augusta, SC (US)

Correspondence Address: J. BENNETT MULLINAX, LLC, P. O. BOX 26029, GREENVILLE, SC, 29616-1029, US

(73) Assignee: Washington Savannah River Co., LLC, Aiken, SC (US)

(21) Appl. No.: 11/525,883

(22) Filed: Sep. 22, 2006

(51) Int. Cl. G01V 5/00

(52) U.S. Cl. 250/253; 348/82

(57) ABSTRACT

A hand-held portable video camera and radiation monitoring apparatus which can be deployed by a single operator in the field is disclosed. The apparatus uses a compact, extendable probe which provides real time visual monitoring via a video camera along with real time radiation detection and identification of isotopes. The apparatus includes software which identifies and reports to the operator via a speech synthesizer the identification of specific isotopes.

### STATEMENT AS TO RIGHTS TO INVENTIONS MADE UNDER FEDERALLY SPONSORED RESEARCH AND DEVELOPMENT

This invention was made with Government support under Contract No. DE-AC0996-SR18500 awarded by the United States Department of Energy. The Government has certain rights in the invention.

### FIELD OF THE INVENTION

This invention is directed towards a hand-held portable, multiple, video camera and radiation monitoring apparatus which can be deployed by a single operator in the field. The apparatus uses a compact, extendable probe which provides real time visual monitoring via video cameras along with real time radiation detection and identification of isotopes. The apparatus includes hardware and software which identifies and reports to the operator via a speech synthesizer the identification of specific isotopes.

### BACKGROUND OF THE INVENTION

This invention is directed toward radiation probes and sensors. There are a variety of radiation probes, Geiger counters, radiation detector tubes, and similar devices that can be used in the field to locate and map radiation fields. It is also known in the art to provide for radiation detectors which provide voice identification of isotopes as seen in assignee's U.S. Pat. No. 5,304,808, Method and Apparatus For Data Sampling, which is incorporated herein by reference.

It is also known in the art to provide units which provide for radiation monitoring and mapping capabilities such as that seen in U.S. Pat. No. 5,936,240, Mobile Autonomous Robotic Apparatus For Radiologic Characterization, and which is incorporated herein by reference.

However, existing radiation sensors, probes, and video monitors have limited capability in visualization and detection of remote, inaccessible areas. Areas such as pipe conduits, crawl spaces, tank interiors, bore holes, and similar locations are not readily accessible to conventional radiation detectors.

Accordingly, there remains room for improvement and variation within the art.

### SUMMARY OF THE INVENTION

It is one aspect of at least one of the present embodiments to provide a probe for detecting radiation comprising a housing having a first end and a second end, the housing having a portion of an exterior wall defining a material transparent to light; a first video camera positioned at a first end of the housing; a second video camera positioned within the housing and facing in a direction opposite the first video camera; a mirror positioned within the housing and positioned within an optical pathway of the second video camera; a motor operatively engaging the mirror; and, a radiation detector positioned within the housing.

It is yet another aspect of at least one of the present embodiments to provide for a portable remote camera and radiation monitor in which a combination video and radiation probe is carried on the first end of a telescopic member; a second end of the telescopic member supporting a reel; the reel providing a storage area for connective cables extending through an interior of the telescopic member in communication with at least one video camera; and, at least one radiation sensor carried by the terminal end of the telescopic member.

It is yet another aspect of at least one of the present embodiments to provide for a combination video and radiation probe in which a rotating cable wheel has positioned thereon radiation sensors in a fixed communication with a cable held on the cable reel. Placement of the electronics associated with a processor board for receiving signals from a radiation sensor avoids any degradation of measurement quality which would otherwise be caused by rotating electrical connections.

These and other features, aspects, and advantages of the present invention will become better understood with reference to the following description and appended claims.

### BRIEF DESCRIPTION OF THE DRAWINGS

A fully enabling disclosure of the present invention, including the best mode thereof to one of ordinary skill in the art, is set forth more particularly in the remainder of the specification, including reference to the accompanying drawings.

FIG. 1 is a right front perspective view of the combined video camera and radiation sensor apparatus.

FIG. 2 is a side view of the components of the portable remote camera and radiation monitor.

FIG. 3A is an enlargement of the video and radiation sensor housing carried on a terminal end of the telescopic member of the portable remote camera and radiation monitor.

FIG. 3B is a plan view of the terminal end of the sensor housing seen in FIG. 3A.

FIG. 4 is a median, longitudinal section through a portion of the telescopic member showing details of the internal construction.

FIG. 5 is an internal view of the reel portion of the apparatus showing details of the sensor processor and electronic connector.

### DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

In describing the various figures herein, the same reference numbers are used throughout to describe the same material, apparatus, or process pathway. To avoid redundancy, detailed descriptions of much of the apparatus once described in relation to a figure is not repeated in the descriptions of subsequent figures, although such apparatus or process is labeled with the same reference numbers.

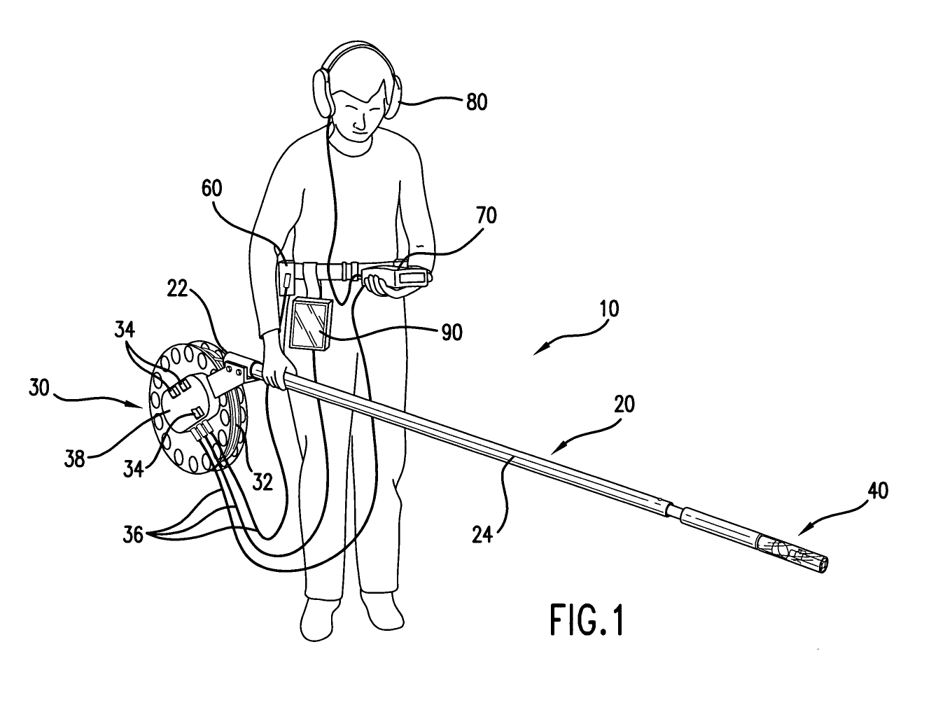

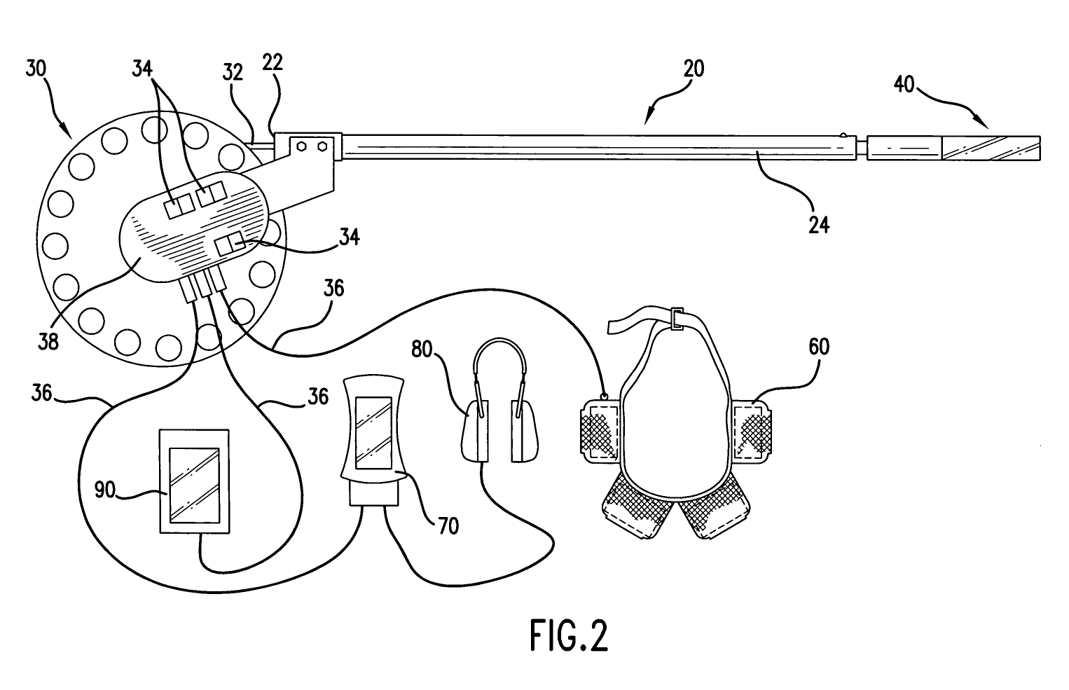

As set forth in FIGS. 1 and 2, a portable remote camera and radiation monitoring apparatus 10 is illustrated. The apparatus 10 is designed to be carried by an operator who can physically position the apparatus 10 to provide guidance for positioning of apparatus 10 in response to real time video and radioisotope monitoring.

As seen in reference to FIGS. 1 and 2, apparatus 10 comprises a telescopic pole 20 which, in one preferred embodiment, may extend from a length of about 5 to about 25 feet. A base portion of telescopic pole 20 has affixed thereto a reel 30 adapted for supporting a length of electrical cable 32 The cable 32 may include a combination of coaxial cables and wires in a common jacket. The cable 32 contains 2 coaxial cables for communication with the radiological detector, 2 coaxial cables for the video cameras (one for each), 2 power conductors for the lights, and 6 additional wires for the camera power and mirror motor.

Reel 30 also contains a spring motor mechanism for maintaining a length of cable in an approximately constant tension arrangement as the cable 32 is deployed. The nearly constant tension allows extension or retraction of the pole 20, or the direct downward deployment of the housing 40 when it is released from the pole 20. The reel is designed to release the cable when the pole is extended and also facilitates the removal of a housing 40, as best described below, from pole 20. The ability to remove the housing allows the apparatus 10 to be used as a drop-down sensor into a bore hole, or lowered vertically into a tank enclosure. Housing 40 is preferably sealed against moisture and liquids such that housing 40 may be immersed in liquids while still carrying out the video and radiation detection functions. Conventional seals between housing 40 and the interconnected cable 32 are used to maintain the integrity of housing 40.

As best seen in reference to FIG. 2, a base portion of telescopic pole 20 defines an opening 22 through which the electrical cable 32 may be inserted into the interior of pole 20. Telescopic pole 20 may be provided from fiberglass or some other, preferably non-conductive, material. Fiberglass or plastic materials provide a combination of strength as well as desired flexibility when the apparatus 10 is in a fully extended position. In addition, materials such as fiberglass and plastics are sufficiently light weight so as to maintain the portability of the apparatus while still permitting the apparatus to be used by a single operator. The non-conductive nature of the pole adds additional protection to the operator in the case of contact with energized conductors during search operations.

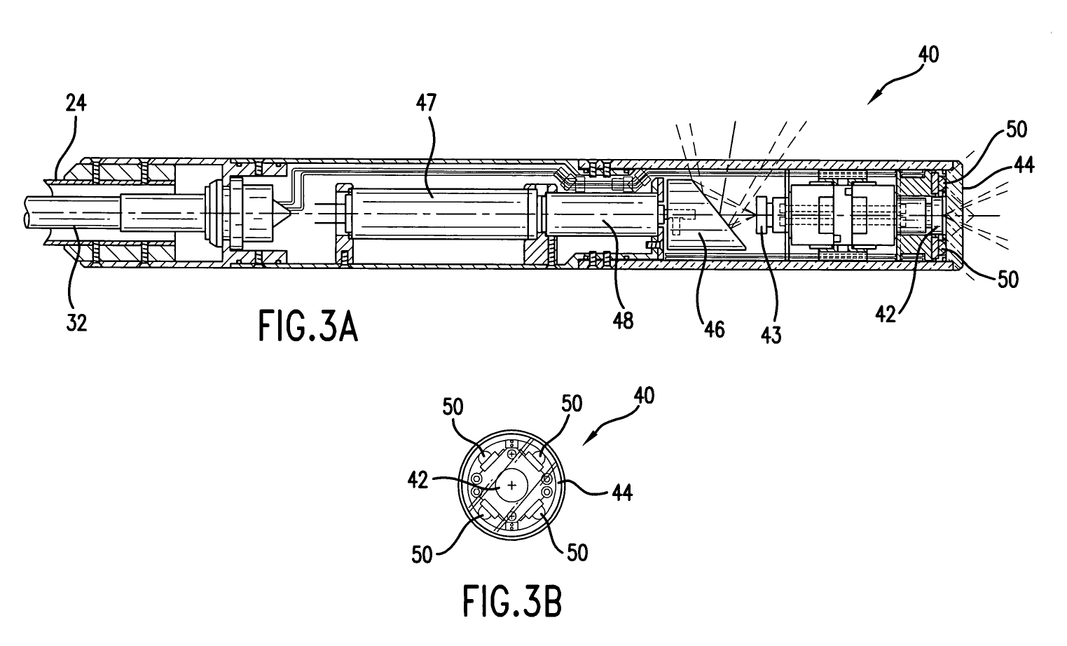

A terminal tip of telescopic pole 20 defines a housing 40 as best seen in reference to FIGS. 3A and 3B. Housing 40 is preferably constructed of an optically transparent material which also permits the passage of radioisotope radiation. One suitable material is Lexan®. It is also envisioned that the housing may be constructed of an opaque material (transparent to radioisotope radiation) having glass or Lexan® viewing windows for the cameras as described below.

A first camera 42, such as a miniature color video camera, Supercircuit's Model PC182 (Liberty Hill, Tex.) is positioned within the housing having a field of view which extends through the optically clear tip of housing 40. A second camera 43 is positioned behind camera 42, the field of view of camera 43 extending in an axial direction opposite that of camera 42. A mirror 46 is positioned at an approximate 40° angle and within the field of view of camera 43 such that camera 43 is able to view images along the exterior side of housing 40. The slight forward bias in the tilt of the field of view of camera 43 provides a field of view compatible with the view of the forward looking camera 42. A motor 48 is attached to mirror 46 and is used to rotate mirror 46 within housing 40. In this manner, camera 43 is able to visualize a 360° exterior view along the side of housing 40.

As seen in reference to FIG. 3A, a plurality of lights 50 may be positioned within an interior of housing 40 so as to illuminate the various fields of view of cameras 42 and 43. While the number, type, and position of lights may vary, it is helpful to mount lights appropriately so as to avoid internal scattering and reflection of light within the housing 40 which could degrade the image quality of the video camera. To minimize reflections and degradation of the images, it is useful to use high intensity (one watt each) LEDs, as the light source which provide for bright illumination, generate little heat, and have low power consumption requirements. The housing 40 is constructed such that the LEDs will not reflect light internally which could create lens flare, rather all light is directed through the transparent housing without internal reflections. This arrangement prevents unwanted reflections from degrading the quality of the images.

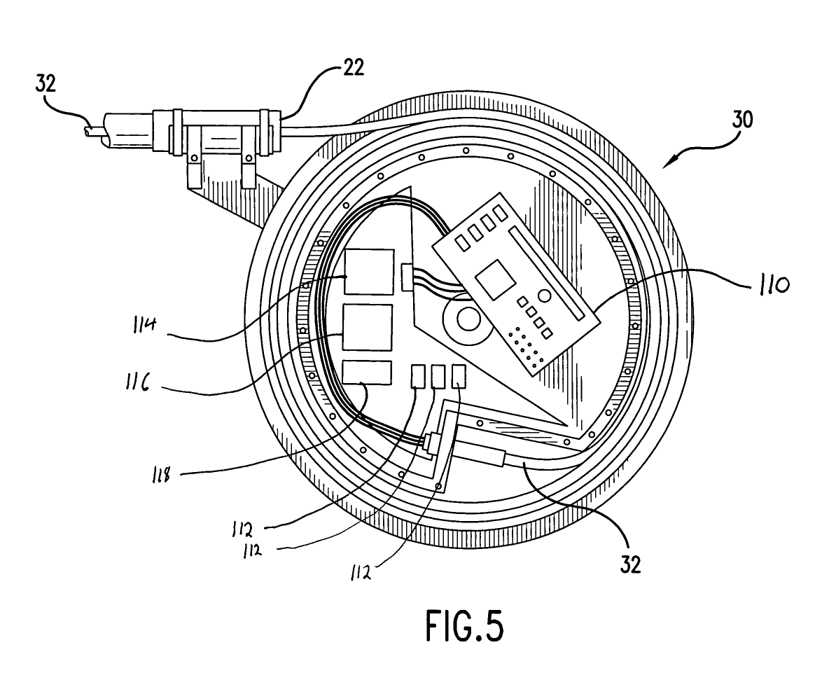

Some of the conductors of the cable 32 connects directly to the radiological sensor processing board 110 as shown in FIG. 5. The processing board is mounted within the reel and rotates with the reel as the cable is pulled in or out. This arrangement allows all of the very sensitive radiological sensor signals and high voltage signals to be connected before encountering any slip rings or similar connection which can degrade their quality or be compromised by the high voltages. The process board collects radiological spectrum data and outputs it to the PDA where radiological isotope identification is performed. The output side of the processing board is connected through a slip ring assembly to the external components, including the PDA and power supply. Since only amplified signals and power signals are transferred through the slip rings, the signal quality of the radiological signals is preserved. Also, the coaxial cables that connect directly between the tip based radiological sensor and the processor board, the high voltages present on these cables are not a factor in the choice of the slip rings, since they are isolated from the slip rings. Power supplies 114, 116, and 118, and control relays 112 as shown in FIG. 5 supply power to the processor board 110 (supply 118), to the tip mounted video cameras 42 and 43 (supply 116), and to the LEDs 50 (supply 114). The control relays switch power to the mirror motor 48 as controlled by the operator using the reel mounted switches 34 for mirror rotation in either direction.

As seen in reference to FIG. 2, reel 30 further defines a plurality of switches 34 that are used to control the power, the camera selection, and the mirror rotation for the side view camera. Additionally, a reel housing 38 further defines entrance for a variety of connectors 36 which extend from the apparatus 10 to remote elements of the apparatus. As illustrated, connectors 36 are used to provide communication with a portable power source 60, seen here in the form of a plurality of batteries in a wearable belt configuration and which powers all the electrical needs of apparatus 10; a PDA 70 which contains software driven menu options and includes radionuclide recognition software; and a hand-held video monitor 90 which is used by the operator to view the video camera feeds.

The PDA 70 also provides data storage capability for the video and radiation detector data such that the stored information may be downloaded to a separate computer and/or analyzed in greater detail following data acquisition. As seen in reference to FIG. 2, the PDA 70 also provides an auditory output jack which permits the operator to use a headphone 80 to monitor output from the PDA 70.

The auditory output from PDA 70 includes a user selected menu of tones and alerts when radiation levels exceed a predetermined background level. In addition, the PDA 70 includes isotope identification software which identifies specific isotopes using human speech as set forth in U.S. Pat. No. 5,304,808, Method and Apparatus For Data Storage, and which is incorporated herein by reference.

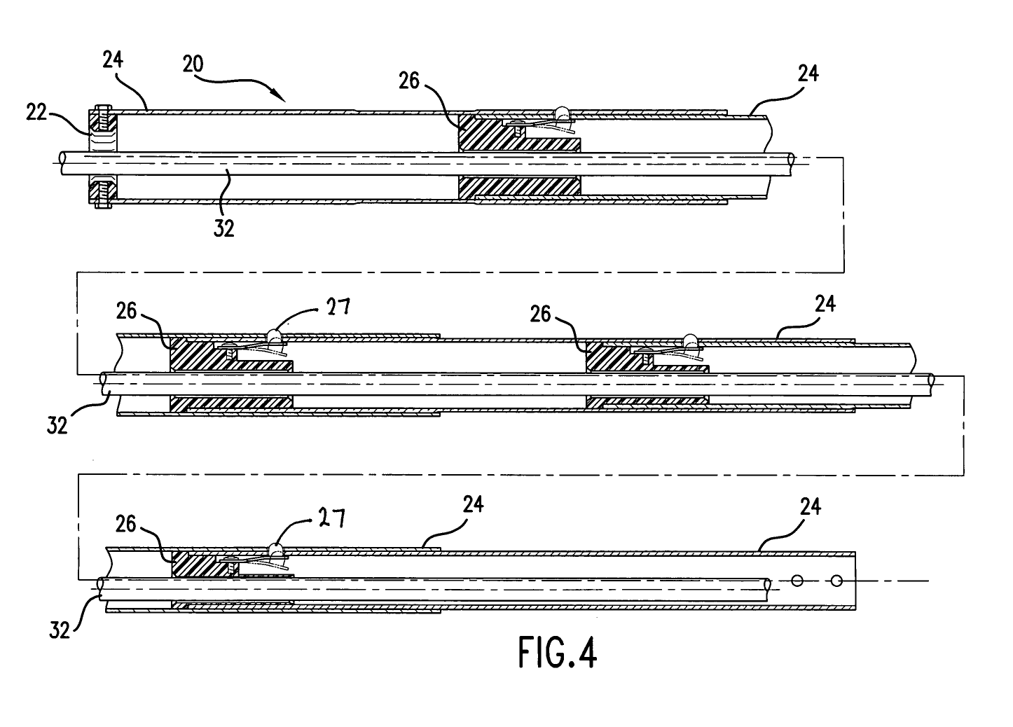

The telescopic member 20, as best seen in reference to FIG. 4, may consist of nestable lengths of fiberglass or plastic tubes 24. As illustrated, the base tube segment 24 associated with reel 30 has the greatest tube diameter from which a series of smaller diameter tubes 24 extend. Each respective tube 24 has an outer diameter which is less than the inner diameter of the adjacent tube from which the individual tube extends. In a fully retracted position, the tube segments 24 nest within the interior of the base tube segment.

As further set forth in FIG. 4, each tube segment 24 contains therein a guide member 26 which is positioned within the interior hollow space of the tube segments 24. Guide member 26 facilitates the extension and retraction of the telescopic tube segments 24 and also provides for a passageway in which an electrical line may be fed therethrough. The guide member 26 is attached to one end of each tube and includes a spring loaded release button 27 that allows the tubing section outside of it to lock in the fully extended position. The guide member 26 also limits the maximum travel of the next, outer, section such that the latter cannot pull all the way out. An internal passage is provided in the guide member 26 to allow the cable 32 to slide freely through it as the sections and cable are extended.

The remote camera and radiation monitor apparatus 10 provides a useful field instrument for visual inspection, monitoring, and detection of radiation sources. The extendable, telescopic member allows the probe to be placed into crevices and passageways that are otherwise inaccessible to a human operator. Further, the spring-loaded spool of cable within the reel allows the housing assembly to be removed from the tip of pole 20 and to be lowered to a depth of 50 feet within an interior of a tank, subsurface bore, or into the interior of a building or other structure.

The operator of apparatus 10 uses the PDA 70, headphones 80, and video monitor 90 to control and use the apparatus 10. The integrated software is a self-calibrating system which automatically establishes a background radiation level and provides for selectable alarm levels.

In an initial “search mode” the software generates a periodic tone indicating the system is in operation. As the operator attempts to locate radioactive sources, the frequency of the tone increases as the detector approaches a radioactive source. At a threshold level of detection, an alarm will sound for the operator at which point the software compares the radiation spectrum to a known library of isotopes. Upon achieving a match between known isotopes, the specific isotope may be displayed on the PDA screen as well as enunciated by a software speech protocol to the operator.

The construction of the housing with multiple cameras and rotatable mirror allows both forward and side views to be obtained relative to the tip housing. The video feed may be monitored by the operator on screen 90.

The operator can easily engage switches 34 located on reel 30, switches 34 controlling the power for the components including selection between camera views and rotation of the mirror of the side viewing camera.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention which is set forth in the following claims. In addition, it should be understood that aspects of the various embodiments may be interchanged, both in whole, or in part. Therefore, the spirit and scope of the appended claims should not be limited to the description of the preferred versions contained therein.

That which is claimed:

1. A probe for detecting radiation comprising:
a housing having a first end and a second end, said housing having at least a portion of an exterior wall defining a material transparent to light and radiation;
a first video camera positioned at a first end of said housing;
a second video camera positioned within said housing and facing in a direction opposite said first video camera;
a mirror positioned within said housing and within an optical pathway of said second video camera;
a motor operatively engaging said mirror; and,
a radiation detector positioned within said housing.

2. A probe for detecting radiation comprising:
a telescopic member having a first end and a second end, said second end of said telescopic member supporting a reel;
a supply of electrical communication line supported within said reel, a first end of said electrical communication line being threaded through an interior of said telescopic member and in further communication with a housing carried on a first end of said telescopic member;
a first video camera and a second video camera positioned within said housing;
a mirror positioned within an optical pathway of at least one of said first and said second video cameras;
a motor operatively engaging said mirror; and,
a radiation detector positioned within said housing wherein said probe permits the placement of said housing into areas inaccessible to a human operator.

3. A process for detecting radiation in limited access areas comprising:
providing a probe for detecting radiation, said probe comprising a telescopic member having a first end and a second end, said second end of said telescopic member supporting a reel;
a supply of electrical communication line supported within said reel, a first end of said electrical communication line being threaded through an interior of said telescopic member and in further communication with a housing carried on a first end of said telescopic member;
a first video camera and a second video camera positioned within said housing;
a mirror positioned within an optical pathway of at least one of said first and said second video cameras;
a motor operatively engaging said mirror; and,
a radiation detector positioned within said housing wherein said probe permits the placement of said housing into areas inaccessible to a human operator;
positioning said probe through an extension of said telescopic member into a region for which a radiation measurement is desired;
using at least one of said first and said second video cameras to inspect a region surrounding said housing;
providing to said human operator a real time radiation measurement to an operator controlled display screen.

4. The probe according to claim 2 wherein said probe further provides a first connector for attachment of a power supply.

5. The probe according to claim 4 wherein said probe comprises a second connector for a video monitor.

6. The probe according to claim 5 wherein said probe further defines a third connector for communication with a PDA.

7. The probe according to claim 6 wherein said PDA is in further communication with headphones worn by said operator.

8. The probe according to claim 1 wherein said probe further comprises a processor in communication with said radiation sensor, said processor in further communication with a PDA which provides an alarm mechanism to a user when a detected radiation level exceeds a predetermined background level.

9. The probe according to claim 8 wherein said PDA further includes an isotope identification software which provides specific isotope identification information to said operator.

10. The probe according to claim 1 wherein said mirror is positioned at an approximate 40° angle relative to an axis of said probe.

11. The probe according to claim 2 wherein said mirror is positioned at an approximate 40° angle relative to an axis of said probe.

12. The probe according to claim 2 wherein a processor board for receiving signals from said radiation detector is supported on said reel.
